(19) United States
(12) Patent Application Publication
(10) Pub. No.: US 2006/0184936 A1
(43) Pub. Date: Aug. 17, 2006

(54) System and method using virtual machines for decoupling software from management and control systems

(76) Inventors: Timothy Abels, Pflugerville, TX (US); Balasubramanian Chandrasekaran, Austin, TX (US)

Correspondence Address: HAMILTON & TERRILE, LLP, P.O. BOX 203518, AUSTIN, TX, 78720, US

(21) Appl. No.: 11/056,639

(22) Filed: Feb. 11, 2005

(51) Int. Cl. G06F 9/455

(52) U.S. Cl. 718/1

(57) ABSTRACT

Virtual machines of a virtual data center generate runtime instances with a software image, hardware configuration, management configuration and user/service configuration. Virtual data center resource use is monitored by reference to the management configuration of runtime instances, such as for environmental controls like power, cooling and balancing, or for policy limitations on users, software or hardware. Users or services generate runtime instances of stored virtual machines by reference to the user/service configuration, such as pricing or priority. In one example embodiment, the virtual machine software image comprises an application system preparation file that populates a read only application image common to plural virtual machines. Information unique to each virtual machine with respect to the application is maintained in the user/service configuration of the virtual machine and version information is maintained in the management configuration of the virtual machine. Updates to the application across each virtual machine are performed by updating the read only image or any of its configuration information for hardware configuration, management configuration or user/service configuration.

### RELATED APPLICATIONS

The present application relates to U.S. patent application Ser. No. ______ entitled “System and Method Using Virtual Machines for Decoupling Software from Users and Services” and U.S. patent application Ser. No. ______ entitled “System and Method for Centralized Software Management in Virtual Machines,” both filed contemporaneously with this application and having the same inventorship and assignee.

### BACKGROUND OF THE INVENTION

1. Field of the Invention

The present invention relates in general to the field of information handling system virtual machines, and more particularly to a system and method using virtual machines for decoupling software from management and control systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically process information with one or more applications running on an operating system that coordinates operation of hardware components. Although discrete information handling systems are effective tools for managing information associated with specific locations or activities, often the processing capabilities of an information handling system are underutilized during inactive time periods. For instance, an information handling system associated with a particular business function may stand idle for extended periods so that it is available when needed. During the idle periods, the physical processing components, such as the processor and storage components, consume power and depreciate with limited added value for the business. Businesses have generally accepted the cost of idle periods in exchange for the convenience of having essential information handling systems on line and ready for important operations.

A recent shift towards the use of resource virtualization has allowed businesses to have the convenience of discrete information handling systems without the expense of maintaining and operating separate physical systems. Resource virtualization decouples software applications from hardware information handling systems by placing the software applications in “virtual machine” containers. A virtual machine is a software abstraction of the hardware layer that provides all of the functionality of a physical hardware system having operating systems and applications installed just like a physical information handling system. A conventional virtual machine can physically be thought of as two files, a software image and a generic hardware configuration file which may be based on Extensible Markup Language (XML). The software image represents the hard disc drive for that virtual machine, typically referred to as a “virtual disc”. The virtual disc typically contains Operating Installation files, Application files and User Data files. Plural virtual machines are stored in a networked server environment typically referred to as a virtual data center so that a desired virtual machine is available for operation on the server resources as needed. Virtual machines are not bound to specific resource instances so that resources may be provisioned and resized dynamically to applications as required and, vice versa, applications may migrate between resources as demands for resource usage shift. Virtual machine hardware configuration files include sizing and current-binding detail to support movement of virtual machines across hardware and vice versa.

Typically, a virtual data center manages virtual machines with data-center-wide data models, such as Microsoft System Definition Model (SDM) and EDS Data Center Markup that allow configuration sharing across software lifecycles, management systems and virtualization systems by using static and non-distributed data. However, within a virtual data center, software remains tightly coupled to management and control systems, which in turn tightly couples management systems with hardware and users. In other words, the flexibility of virtual machines to run on various resources is restricted by the management of the virtual machines and the virtual data center, such as management of updates, performance, locations, priorities and privileges. As an example, in a data center environment, software management is distributed with each applicable system having to be managed individually. This makes software management operations such as patch management tedious and time consuming. In order to do software installation, patch management and security updates, each system in a data center must be upgraded and security patches installed on an individual basis. A typical data center has thousands of virtual machines so that resources are inadequate to update all virtual machines at the same time, resulting in a heterogeneous environment with some systems upgraded and some using old versions. Tracking system upgrades to ensure that all systems are upgraded presents a substantial logistical problem that is often repeated several times a year as patches are released. Software within a virtual data center also remains tightly coupled to users and user-like services, such as by limiting the use of software with software applications matched to users for ensuring that software and hardware adheres to user-specific preferences, such as security, isolation, utilization and billing/chargeback.

### SUMMARY OF THE INVENTION

Therefore a need has arisen for a system and method which uses virtual machines to decouple software from users and services.

A further need exists for a system and method which uses virtual machines to decouple software from management and control systems.

A further need exists for a system and method which simplifies software management of virtual machine software across a virtual data center.

In accordance with the present invention, a system and method are provided which substantially reduce the disadvantages and problems associated with previous methods and systems for managing virtual machines of a virtual data center. Runtime instances of virtual machines are generated from management configuration information and user/service configuration information coupled to the virtual machine. Thus, virtual machines are effectively used to decouple virtual data center management and control systems from user and user-like services.

More specifically, virtual machines of a virtual data center include a software image and server hardware configuration that run on server hardware resources as assigned by a resource virtualization engine. In addition, each virtual machine includes a separate management configuration having management preferences and user/service configuration having user preferences. The management preferences include information for management related functions, such as environmental controls like power, cooling and balancing, policies, minimums, maximums or limits on users, software or hardware. A resource use monitor engine monitors activated virtual machines in a closed loop with a global policy engine to adjust allocation of virtual machines across processing components of server resources according to the management preferences. User/service preferences include information for priority and cost of a virtual machine as well as other parameters, such as backup preference and frequency or security levels. The user/service and management configurations make virtual machines self-contained across generic hardware, users and system management for dynamic allocation to processing components to meet desired management and service goals.

In one embodiment, the management and user/service configurations maintain information to allow generation of virtual machine instances from an application read only image. For instance, the management configuration tracks the application type and the user/service configuration tracks system unique information. Instead of having a separate virtual disc for each virtual machine, a common virtual disc is used for plural virtual machines that share the same operating system and applications, with a separate virtual disc used for files that are unique to individual virtual machines, such as user data files. An instance of a particular virtual machine runs from a copy of the common virtual disc populated with unique information from the unique virtual disc. Information generated by the instance is written to the unique virtual disc with the common virtual disc maintained as read-only to protect the integrity of other virtual machines that use the common virtual disc. Access to alter the common virtual disc is limited, such as limited to a patch manager that has write permission to install patches or security updates to applications on the common virtual disc. For example, a patch is installed across plural virtual machines by shutting down all running instances that use a common virtual disc, applying the patch to the common virtual disc, and restarting the plural virtual machines from the updated common virtual disc so that instances run with the patch.

The present invention provides a number of important technical advantages. One example of an important technical advantage is that virtual machines are used to decouple software from management and control systems of a virtual data center. Decoupling of management and control allows a more flexible model that matches management to generic systems of users, software and hardware, manages multiple systems, allows independent changing of management, users, software or hardware even while running a virtual machine and ensures that management adheres to policy rules, such as environmental compliance, and hardware adheres to management-specific limits, such as policies or maximum physical limits. Decoupling of software from management and control allows software changes independent of management, updates to running and stateful software while management systems are accessing it and simplifies management system updates, such as for manager changes in views, performance, locations, priorities and privileges. Virtual machines are self-contained across generic hardware, users and system management to provide a complete and reproducible snapshot that simplifies virtual data center tool categories, such as diagnostics, checkpoint, backup, cloning, suspend/resume and chargeback/billing. Versioning of files within a virtual machine simplifies tracking of management updates and the separate management configuration file allows role-based access to configurations within a virtual machine. Virtual machines are self-contained across generic hardware, users and system management to provide a complete and reproducible snapshot that simplifies virtual data center tool categories, such as diagnostics, checkpoint, backup, cloning, suspend/resume and chargeback/billing. Versioning of files within a virtual machine simplifies tracking of updates and the separate user configuration file allows role-based access to configurations within a virtual machine.

Another example of an important technical advantage is that virtual machines are used to decouple software from users and services of a virtual data center. Decoupling of users and services allows a more flexible model that matches software applications to users, ensures that software adheres to user-specific preferences, such as security, and ensures that hardware adheres to user-specific preferences, such as isolation, utilization and billing/chargeback. Decoupling of software from users and services allows software changes independent of users, updates to running and stateful software while users are accessing it, and simplified user updates to views, performance, locations, priorities and privileges.

Another example of an important technical advantage with virtual machines is that software management across a virtual data center is simplified. A patch to an application is applied to a read-only copy of the application. Virtual machines that include the application boot from the read-only image to include the patch so that applying the patch to the application a single time effectively updates all virtual machines that include the application. The use of the read-only image to support boot of multiple virtual machines reduces overall storage at the virtual data center since the read-only copy of the application may be maintained as the only permanent copy of the application and all virtual machines using the read-only copy share a common state with respect to the application. In addition, cloning of virtual machines having the same configuration is performable in a reduced time since the user service configuration file associated with the application is copied without requiring copying of the entire application. In addition, applications are self-contained with sufficient information to be independent of specific bindings to users and services, system management or hardware.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a virtual data center having management configurations and user/service configurations associated with each virtual machine;

FIG. 2 depicts a block diagram of a virtual data center having an application read only image that supports runtime images of plural virtual machines having application system preparation files; and

FIG. 3 depicts a layered view of virtual machines having a common image.

### DETAILED DESCRIPTION

Virtual machine instances are generated and monitored in a virtual data center by reference to information in a management configuration and a user/service configuration associated with each virtual machine. The management and user/service configurations aid in assignment and monitoring of virtual machines to information handling system processing resources to achieve desired goals. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

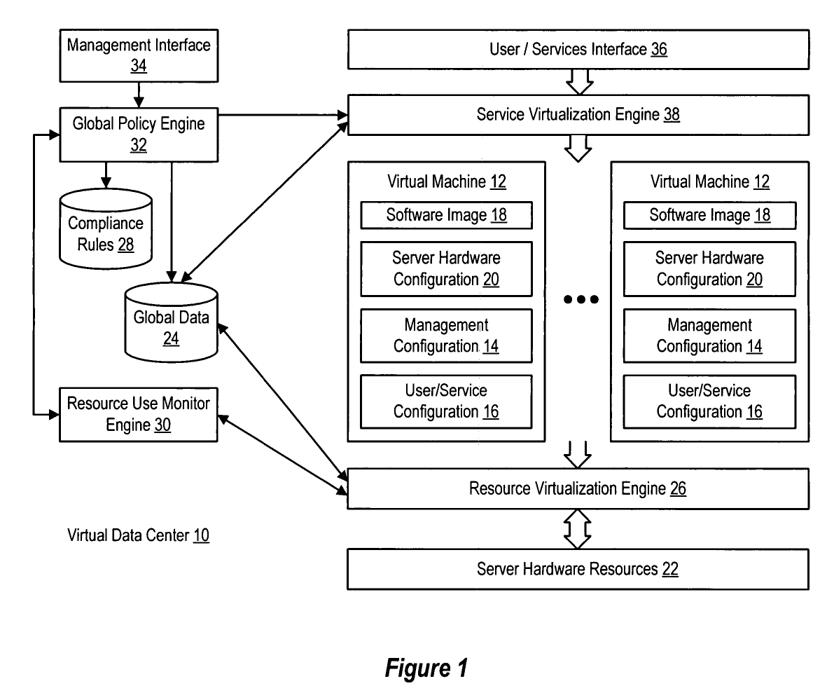

Referring now to FIG. 1, a block diagram depicts a virtual data center 10 having management configurations 14 and user/service configurations 16 associated with each virtual machine 12. Virtual machines 12 operate on server hardware resources 22 by calling a software image 18 to run based on a server hardware configuration 20. Inactive virtual machines are stored in global data 24 and activated by assigning a stored virtual machine to desired processing components of server hardware resources 22 through a resource virtualization engine 26. For instance, a data processing function is performed at the end of a business day by calling a virtual machine 12 that performs the data processing function once the data becomes available. Resource virtualization engine 26 assigns the virtual machine 12 to a CPU of server hardware resources 22 and boots the operating system of virtual machine 12 on the CPU to run the function. Upon completion of the data processing function, resource virtualization engine 26 deactivates the virtual machine 12 for storage in global data 24. Conventional virtual data centers tightly coupled software to the management and control systems as well as to the user and user-like services performed, thus limiting virtual data center operational flexibility, such as by tightly coupling management systems with hardware and users. Virtual data center 10 of FIG. 1 includes a management configuration 14 and user/service configuration 16 with each virtual machine 12 to decouple software from management and control systems and from user and user-like services for improved operational flexibility.

Management configuration 14 provides improved flexibility by coupling management information to each virtual machine 12 to allow matching of management to generic systems of users, software and hardware, to allow managing of multiple systems, to allow independent changes to management even while running the virtual machine 12, to allow independent changes to users, software or hardware even while running, to ensure that management adheres to policy compliance rules 28 such as environmental compliance, and to ensure hardware adheres to management specific limits such as policies or maximum physical limits defined by policy compliance rules 28. Management configuration 14 may be an XML file that stores management preferences in a standardized format. The coupling of management preferences to virtual machines with management configuration 14 supports manager inputs to virtualization layers through a resource use monitor engine 30 and manager outputs to virtualization layers through a global policy engine 32 to avoid conflicts in manager updates to users, software and hardware while virtual machines are running. For example, management configuration 14 defines preferences for views, performance, location, priorities and privileges of a virtual machine. The preferences may be updated through a management interface 34 while a virtual machine is running by changing the values within the management configuration. Role-based updates provide authority to change management configuration values based on access levels approved by global policy engine 32. Since management preferences are maintained as part of the virtual machine itself, complete reproducible snapshots of a virtual machine simplify tasks for a number of tools, such as diagnostics, checkpoint, backup, cloning, suspend/resume, and chargeback/billing, and versioning may be tracked in the management configuration.

One example of management configuration preferences is environmental goals such as relating to power, cooling and task balancing within a virtual data center. Resource use monitor engine 30 monitors virtualization runtime based on environmental goal management preferences rather than direct monitoring of hardware since a given virtual resource may not exist physically, globally or long enough to allow discovery, monitoring and management. Resource use monitoring engine 30 creates a feedback loop with global policy engine 32 to dynamically adjust the allocation of virtual machines 12 across the processing components of server hardware resources 22. For instance, as workloads and priorities of virtual machines running across a virtual data center permit, loads are balanced with power cycled on and off at nodes to save energy and gracefully degrade power consumption. As another example, if environmental constraints such as cooling are met, resource use monitor engine 30 analyzes priorities associated with active virtual machine management preferences so that global policy engine 32 may selectively victimize lower priorities to reduce cooling demands. In alternative embodiments, management preferences guide allocation of virtual machines by resource use monitor engine 30 and global policy engine 32 to meet goals related to various policies, minimums, maximums or limits on users, software or hardware. Management configurations are encrypted for role-based security at file or sub-file levels and versioned.

User/service configuration 16 provides improved flexibility by coupling user/service information to each virtual machine 12 to allow matching of software applications to users, to ensure that software adheres to user-specific preferences such as security, and to ensure that hardware adheres to user-specific preferences such as isolation, utilization, and billing/chargeback. User/service configuration 16 is an XML file that stores preferences for users and user-like services in a standardized format. The coupling of user/service preferences to virtual machines with user/service configuration 16 supports manager inputs to virtualization layers through a user/services interface 36 and service virtualization engine 38. Associating management configuration 14 and user/service configuration 16 with a virtual machine provides a fully self-contained system that is dynamic and easily distributable so that applications of a virtual machine may run across generic hardware and users. A fully self-contained virtual machine presents a reproducible snapshot to simplify tools, such as diagnostics, checkpoint, backup, cloning, suspend/resume and chargeback/billing, and allows simplified tracking of version changes over time. Decoupling of virtual machines from users and user-like services with the service configuration allows software changes independent of users, including updates to running stateful software while users are accessing it. Users are update by updates to user/service preferences of the user/service configuration, such as user views, performance, locations, priorities and privileges. Connected users with local cached states are updated by updating the user/service configuration even while the user accesses software.

One example of user/service preferences stored in a user/service configuration is a user/service preference for priority and cost associated with a virtual machine. For instance, a user or user-like service enters price and cost parameters for a virtual machine 12 into user/service configuration 16 through user/service interface 36. Service virtualization engine 38 requests creation of a runtime instance of the virtual machine with the priority and cost preferences so that resource use monitor engine 30 and global policy engine 32 adjust the assignment of the virtual machine to the processing components of the server hardware resources 22 according to the available capacity and pricing constraints set by compliance rules 28. Another example of a user/service preference is the adjustable setting of backup preferences and frequency to ensure data integrity, or the adjustable setting security levels to appropriately restrict access to data. Current binding detail is updated at runtime as changing users and user-states are rebound to changing software and software states. Service virtualization may act as the runtime environment for instances from a virtual machine pool and a pool of users and user-like services to treat virtual machines as a utility resource, including personalization of applications.

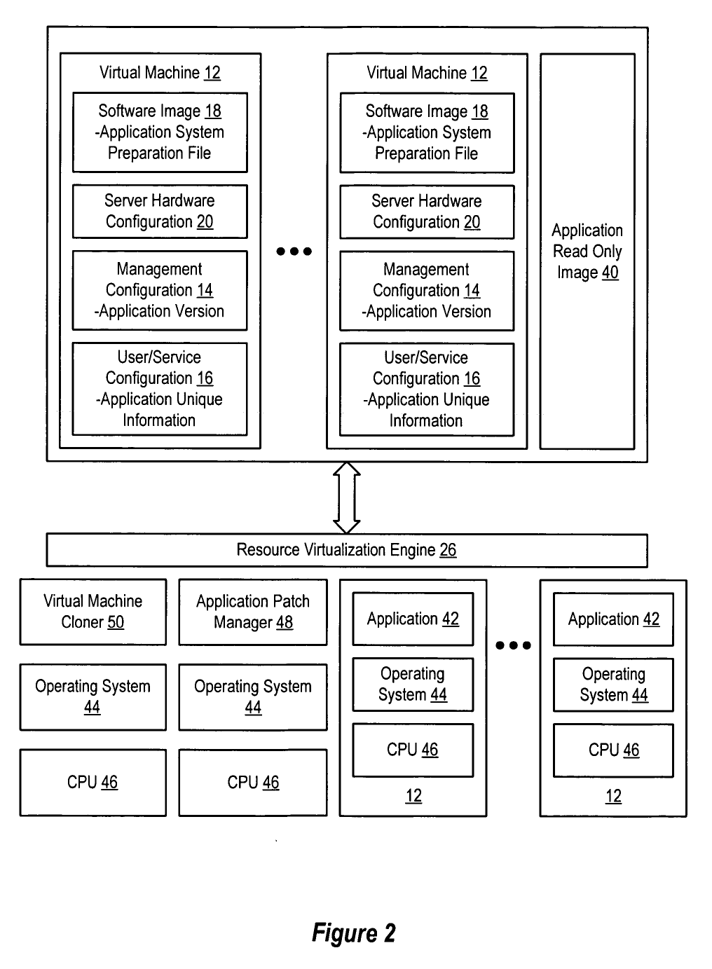

Referring now to FIG. 2, a block diagram depicts a virtual data center having an application read only image 40 that supports runtime images of plural virtual machines 12 having application system preparation files in their software images 18. As a virtual machine 12 is called from global data 24 for operation on server hardware resources 22, resource virtualization engine 26 reads application read only image 40 to boot virtual machine 12 with application read only image 40 populated by information from the application system preparation file stored in software image 18. For instance, application read only image 40 is a read-only copy of a WINDOWS operating system with configuration information unique to each virtual machine's use of the operating system, such as IP address and system name, removed with an appropriate tool, such as running the sysprep program. The application unique configuration information isolated with the sysprep tool is stored in user/service configuration 16 and the version or class of the operating system or application is stored in management configuration 14. Thus, application read only image 40 acts as a gold image to support population of system-unique information into runtime instances of multiple virtual machines across a virtual data center with writes performed to the user/service configuration 16 of the virtual machine.

Population of a common read only application with system unique information provides simplified application maintenance, such as installing updates or patches for the application across a virtual data center, or cloning virtual machines. As depicted by FIG. 2, activated virtual machines 12 have one or more applications 42 running on an operating system 44 and CPU 46. Updates to application read-only image 40 are performed by an application patch manager 48, also running on a virtual machine 12, which has write authority to apply updates or patches to application read only image 40. Before application patch manager 48 applies an update to application read only image 40, virtual machines running the application are either shut down or cached so that reads are not requested from application read only image 40 during the update. Caching of an image of the application before the update allows critical virtual machines to continue operating while the update occurs. After the update is performed by application patch manager 48, the shut virtual machines are restarted to run with the updated application read-only image 40. Virtual machines running off of a cached copy of the pre-update application may be restarted from updated application read only image 40 at a convenient time. The use of a single point for software management ensures that all virtual machines using application read-only image 40 are updated in a single operation with less use of storage resources. Similarly, leverage of the application read-only image during cloning of a virtual machine by a virtual machine cloner 50 reduces the time and resources needed to perform cloning. Copy time is reduced by copying the software image with the application system preparation file without copying application read only image 40.

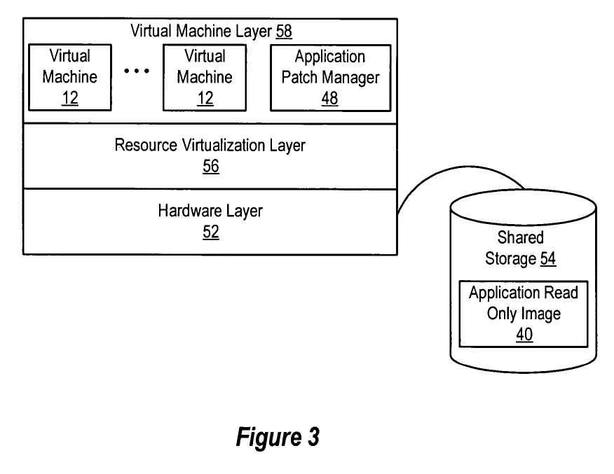

Referring now to FIG. 3, a layered view is depicted of virtual machines having a common image. A hardware layer 52 has the physical hardware to support instances of virtual machines, such as processor and memory resources. For example, a data center often includes plural information handling system servers that are allocated to virtual machine instances. The hardware layer includes shared storage 54, such as one or more interconnected hard disc drives. Shared storage 54 stores the application read only image that is cloned to create instances of virtual machines 12. A resource virtualization layer 56 allocates the hardware resources of hardware layer 52 for use by virtual machine layer 58. At virtual machine layer 58, plural virtual machines 12 run as clones of application read only image 40 populated with unique information for each virtual machine 12. Application patch manager 48 runs as a virtual machine that has access to application read only image 40. When patches are applied to a read only image, application patch manager 48 shuts down virtual machines 12 that use a clone of the read only image, apply the patch to the read only image, and then reinitiate the virtual machines 12 running with a clone of the image.

Although the present invention has been described in detail, it should be understood that various changes, substitutions and alterations can be made hereto without departing from the spirit and scope of the invention as defined by the appended claims.

What is claimed is:

1. A virtual data center comprising:
physical processing components operable to run plural virtual machines;
a resource virtualization engine operable to coordinate assignment of virtual machines to the physical processing components;
plural virtual machines interfaced with the resource virtualization engine, each virtual machine having a server hardware configuration defining physical attributes of the virtual machine, a software image defining applications of the virtual machine, and a management configuration defining management preferences, the resource virtualization engine applying the management preferences to assign the virtual machine to the physical processing components.

2. The virtual data center of claim 1 further comprising a global policy engine operable to set the management configuration.

3. The virtual data center of claim 2 wherein the management configuration comprises an XML file associated with each virtual machine, the XML file having a schema that defines the management preferences.

4. The virtual data center of claim 3 wherein the management preferences comprise environmental controls.

5. The virtual data center of claim 3 wherein the management preferences comprise limitations associated with use of the associated virtual machine.

6. The virtual data center of claim 5 wherein the management preferences comprise prioritization preferences for one or more applications.

7. The virtual data center of claim 1 further comprising a resource use monitoring engine interfaced with the resource virtualization engine and operable to monitor physical processing component use by the virtual machines for compliance with the management preferences.

8. The virtual data center of claim 1 wherein each virtual machine further has a user/service configuration defining user/service preferences, the virtual data center further comprising a service virtualization engine interfaced with the virtual machines and operable to apply the user/service configuration to generate runtime instances according to the user/service preferences.

9. The virtual data center of claim 8 further comprising global data storage having plural virtual machines, the virtual machines having at least one common application, the common application accessible as a common read-only image, each virtual machine further having a common application configuration file operable to populate a copy of the common application at generation of a runtime instance of the virtual machine.

10. A method for managing virtual machines operating on a virtual data center, the method comprising:
operating a virtual machine software image with an associated virtual machine hardware configuration on physical processing components;
associating a management configuration with the virtual machine;
monitoring the operating of the virtual machine on the physical processing components; and
adjusting the operating of the virtual machine on the physical processing components according to one or more management preferences in the management configuration.

11. The method of claim 10 wherein adjusting further comprises allocating virtual machines to physical processing components to achieve environmental goals, the allocating performed according to the management preferences.

12. The method of claim 11 wherein the environmental goals comprise physical processing component power, cooling and balancing parameters.

13. The method of claim 12 wherein allocating further comprises cycling physical processing components between on and off states.

14. The method of claim 10 wherein adjusting further comprises allocating virtual machines to physical processing components based on one or more priority parameters of the management configurations.

15. The method of claim 10 wherein adjusting further comprises allocating virtual machines to physical processing components based on resource use limitation parameters of the management configurations.

16. A method for operating virtual machines, the method comprising:
storing virtual machines on permanent storage devices of a virtual data center, each virtual machine having a software image, a hardware configuration and a management configuration;
requesting an operation by an application of the software image;
retrieving the stored virtual machine from the permanent storage;
retrieving management preferences from the management configuration of the virtual machine; and
assigning the virtual machine to operate on physical processing components according to the management preferences.

17. The method of claim 16 wherein the hardware configuration and management configuration comprise separate XML files.

18. The method of claim 16 further comprising:
monitoring operation of applications on the physical processing components;
comparing the operation of the applications with management preferences of the management configuration; and
adjusting the operation of the applications according to the management preferences.

19. The method of claim 18 wherein the management preferences comprise environmental controls and adjusting comprises adjusting physical processing component power, cooling and balancing parameters.

20. The method of claim 18 wherein the management preferences comprise one or more limitation policies associated with one or more of application or physical processing component use and adjusting comprises adjusting allocation of the application to the physical processing components according to the limitation policies.
